(19) United States
(12) Patent Application Publication
(10) Pub. No.: US 2013/0052451 A1
(43) Pub. Date: Feb. 28, 2013

(54) INSULATION COATING METHOD FOR METAL BASE, INSULATION COATED METAL BASE, AND SEMICONDUCTOR MANUFACTURING APPARATUS USING THE SAME

(71) Applicants: Takamichi Sano, Kanagawa (JP); Shinya Miyaji, Kanagawa (JP); Shinji Saito, Kanagawa (JP)

(72) Inventors: Takamichi Sano, Kanagawa (JP); Shinya Miyaji, Kanagawa (JP); Shinji Saito, Kanagawa (JP)

(21) Appl. No.: 13/661,390

(22) Filed: Oct. 26, 2012

Related U.S. Application Data
(63) Continuation of application No. PCT/JP2011/002140, filed on Apr. 12, 2011.

(30) Foreign Application Priority Data
Apr. 26, 2010 (JP) 2010-100985

(51) Int. Cl. C23C 4/10; B32B 15/04; C23C 4/18

(52) U.S. Cl. 428/312.8; 427/454

(57) ABSTRACT

An insulation coating method for a metal base comprises a thermal spraying step, an impregnation step, and a beam irradiation step. In the thermal spraying step, a first insulation coating is formed by thermally spraying a first metal oxide to the surface of the metal base. In the impregnation step, pores formed in the surface of the first insulation coating are impregnated with a sol that contains, as a dispersoid, a metal oxide, a hydrate of a metal oxide, or a metal hydroxide. In the beam irradiation step, a second insulation coating that is composed of a second metal oxide is formed by irradiating the first insulation coating and the sol with a high energy beam after the impregnation step.

### CROSS REFERENCES TO RELATED APPLICATIONS

This application is a continuation-in-part (CIP) application based upon the International Application PCT/JP2011/002140, the International Filing Date of which is Apr. 12, 2011, the entire content of which is incorporated herein by reference, and claims the benefit of priority from the prior Japanese Patent Application No. 2010-100985, filed in the Japanese Patent Office on Apr. 26, 2010, the entire content of which is incorporated herein by reference.

### TECHNICAL FIELD

The present invention relates to a method of forming an insulation coating of metal oxide on a surface of a metal base, an insulation-coated metal base, and a semiconductor manufacturing apparatus using the same.

### BACKGROUND OF THE INVENTION

A metal base on which a thermal spray coating of ceramics is formed is provided with electric insulation, thermal resistance, and durability, and is used in various technical fields such as semiconductors and airplanes. For example, in a semiconductor-manufacturing plasma CVD (Chemical Vapor Deposition) apparatus, such insulation-coated metal bases are used for an internal wall of a chamber thereof and internal members of the chamber. The semiconductor-manufacturing plasma CVD apparatus is an apparatus used to form a silicon thin film by generating plasma in a low-vacuum chamber.

Here, the thermal spray coating of ceramics includes many pores and microcracks, and non-melting regions caused by a short-term heat input process. Therefore, compared with a bulk ceramics sintered body, the thermal spray coating of ceramics is low in electric insulation and corrosion resistance. As for the pores formed on the surface of the thermal spray coating of ceramics, edge portions could easily come off and become a source of particles. Thus, when such an insulation-coated metal base is used in the semiconductor-manufacturing plasma CVD apparatus, the thermal spray coating of ceramics is exposed to plasma, causing the edge portions of pores to come off and generating particles. As a result, there is an increase in contamination, lowering the quality of semiconductor devices.

To solve the above problem, the technique for carrying out sealing treatment after the formation of a thermal spray coating of ceramics has been known. For example, what is disclosed in Japanese Patent Application Publication No. 57-39007 is the sealing treatment that is carried out to fill pores and microcracks by impregnating the thermal spray coating of ceramics with resin. What is disclosed in Japanese Patent Application Laid-Open Publication Nos. 61-104062 and 61-113755 is the sealing treatment that is carried out to remove pores and the like by irradiating the thermal spray coating of ceramics with a high-energy beam and thereby melting ceramics again. What is disclosed in Japanese Patent Application Laid-Open Publication No. 4-266087 is the sealing treatment that is carried out to fill pores and the like by irradiating the thermal spray coating of ceramics with a high-energy beam and then using a sealer such as epoxy resin. What is disclosed in Japanese Patent Application Laid-Open Publication No. 10-306363 is the sealing treatment by which the pores and the like of the thermal spray coating of ceramics are filled with a sealer such as a glaze and then irradiated with a laser beam.

As described above, various kinds of sealing treatment have been proposed. However, as disclosed in Japanese Patent Application Publication No. 57-39007 and Japanese Patent Application Laid-Open Publication No. 4-266087, when a sealer made of resin is used, an insulation-coated metal base cannot be used at a temperature higher than or equal to the melting point of the resin, meaning that the heat-resisting property of the thermal spray coating of ceramics cannot be fully utilized. Moreover, as disclosed in Japanese Patent Application Laid-Open Publication No. 10-306363, even when a sealer made of glaze is used, it is difficult to impregnate fine pores and the like with the sealer because the particle diameter of the glaze is larger than several micrometers.

Furthermore, when an insulation-coated metal base, such as those disclosed in Japanese Patent Application Publication No. 57-39007, and Japanese Patent Application Laid-Open Publication Nos. 4-266087 and 10-306363, is used for a semiconductor manufacturing apparatus, the sealer becomes mixed into semiconductor devices as impurities, resulting in a deterioration in the quality thereof.

The sealing treatment disclosed in Japanese Patent Application Laid-Open Publication Nos. 61-104062 and 61.113755 is designed to remove pores and the like by irradiating a high-energy beam without using a sealer. However, as a result of experiments by the inventors, it was found that large amounts of energy are required to smooth the surface, and that it is difficult to sufficiently remove pores and the like only by irradiating the beam.

### BRIEF SUMMARY OF THE INVENTION

The present invention has been made to solve the above problems. The object of the present invention is to obtain an insulation coating that is excellent in heat resistance with a small number of pores on a surface thereof.

According to an aspect of the present invention, there is provided a metal-base insulation coating method comprising: a thermal spraying step of thermally spraying a first metal oxide to a surface of a metal base to form a first insulation coating; an impregnation step of impregnating pores formed on a surface of the first insulation coating with sol containing a metal oxide, hydrated metal oxide, or metal hydroxide as dispersoid; and a beam irradiation step of irradiating the first insulation coating and the sol with a high-energy beam after the impregnation step to form a second insulation coating made of a second metal oxide.

According to an aspect of the present invention, there is provided an insulation-coated metal base, comprising: a metal base; a first insulation coating that is formed as a first metal oxide is thermally sprayed onto a surface of the metal base; and a second insulation coating that is formed by irradiating the first insulation coating with high-energy beam, pores formed on a surface of the first insulating coating is impregnated with sol that contains a metal oxide, hydrated metal oxide, or metal hydroxide as dispersoid.

According to yet another aspect of the present invention, there is provided a semiconductor manufacturing apparatus, comprising an insulation-coated metal base that includes: a metal base; a first insulation coating that is formed as a first metal oxide is thermally sprayed onto a surface of the metal base; and second insulation coating that is formed by irradiating the first insulation coating with high-energy beam, pores formed on a surface of the first insulating coating is impregnated with sol that contains a metal oxide, hydrated metal oxide, or metal hydroxide as dispersoid.

### BRIEF DESCRIPTION OF THE DRAWINGS

The above and other features and advantages of the present invention will become apparent from the discussion hereinbelow of specific, illustrative embodiments thereof presented in conjunction with the accompanying drawings, in which:

FIG. 1 is a flowchart of an insulation coating method of a metal base according to a first embodiment of the present invention;

FIG. 2 is a schematic diagram of a vacuum impregnation apparatus used in an impregnation process of the insulation coating method of the metal base according to the first embodiment of the present invention;

FIG. 3 is a table showing irradiation conditions of the insulation coating method according to the first embodiment of the present invention and Comparative Example 2;

FIG. 4 is a table showing SEM images of surfaces of insulation-coated metal bases of the first embodiment of the present invention and Comparative Examples 1 and 2, as well as the number of pores formed on the surfaces;

FIG. 5 is a table showing irradiation conditions of the insulation coating method according to a second embodiment of the present invention and Comparative Example 4; and

FIG. 6 is a table showing SEM images of surfaces of insulation-coated metal bases of the second embodiment of the present invention and Comparative Examples 3 and 4, as well as the number of pores formed on the surfaces.

### DETAILED DESCRIPTION OF THE EMBODIMENTS

### First Embodiment

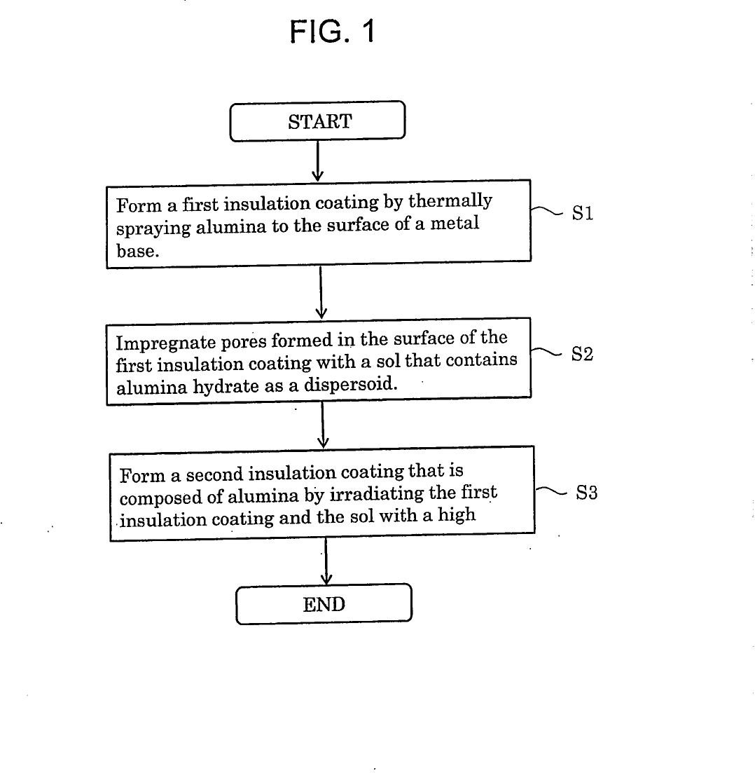

A metal-base insulation coating method and an insulation-coated metal base of a first embodiment of the present invention will be described with the use of FIGS. 1 to 4.

The insulation-coated metal base of the present embodiment is used for an internal wall of a chamber of a semiconductor-manufacturing plasma CVD apparatus, internal members of the chamber, and the like, for example. The semiconductor-manufacturing plasma CVD apparatus is an apparatus used to form, for example, a silicon oxide thin film by generating plasma in a low-vacuum chamber. Accordingly, a surface of the insulation-coated metal base is exposed to plasma.

The insulation-coated metal base of the present embodiment includes a metal base, a first insulation coating, and a second insulation coating. The metal base is made of aluminum, for example. The first insulation coating is made by thermally spraying alumina (Al₂O₃) onto a surface of the metal base. The second insulation coating is formed by irradiating the first insulation coating with an electron beam after the pores on the surface of the first insulating coating is impregnated with sol that contains hydrated alumina as dispersoid.

A method of manufacturing the insulation-coated metal base, i.e. an insulation coating method of the metal base of the present embodiment, will be described with the use of FIG. 1. FIG. 1 is a flowchart of an insulation coating method of a metal base according to the present embodiment. The insulation coating method of the metal base includes a thermal spraying step (S1), an impregnation step (S2), and a beam irradiation step (S3).

First, a first insulation coating is formed as alumina is thermally sprayed onto a surface of the metal base (Thermal spraying step (S1)). More specifically, alumina powder is heated and melted at about 10,000 degrees Celsius, and the melted alumina is sprayed onto the surface of the metal base, thereby forming the first insulation coating with a thickness of about 200 μm. In this state, on a surface of the first insulation coating, a large number of pores that are 1 to 20 μm in size are formed.

Then, the pores and microcracks, which are formed on the surface of the first insulation coating, are impregnated with sol (Impregnation step (S2)). In the sol, hydrated alumina (Al₂O₃.nH₂O) is contained as dispersoid, with a dispersion medium thereof mainly made of water. The average particle diameter of the dispersoid, hydrated alumina, is preferably larger than or equal to 1 nm and smaller than or equal to 100 nm.

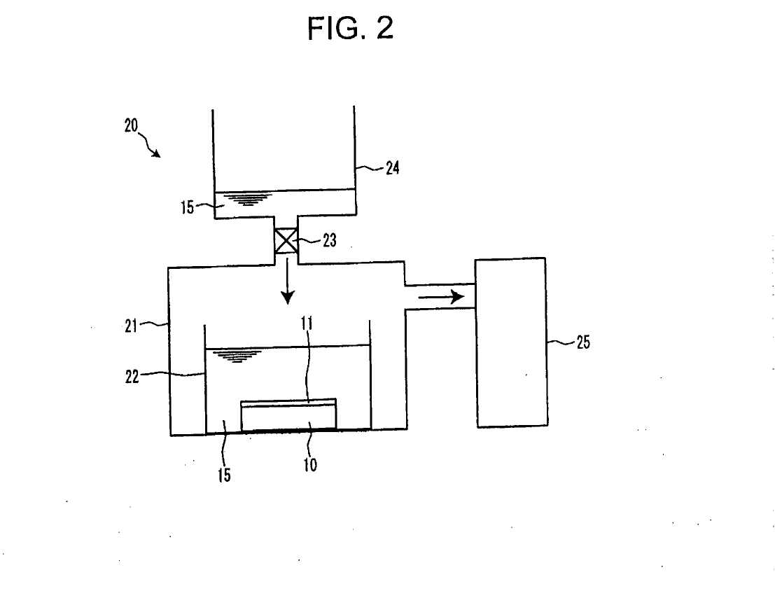

For example, the impregnation step (S2) is carried out using a vacuum impregnation apparatus 20 shown in FIG. 2. A metal base 10 on which a first insulation coating 11 has been formed is placed inside a container 22, which is provided in a chamber 21. Then, a vacuum pump 25 is used to reduce the pressure inside the chamber 21 to about 5 Torr. Then, a valve 23 is opened to supply sol 15, which is stored in a tank 24, into the container 22. The metal base 10 on which the first insulation coating 11 has been formed is dipped into the sol 15 for about 20 minutes, thereby impregnating the insides of the pores, which are formed on the surface of the first insulation coating 11, with the sol 15. Then, the inside of the chamber 21 is opened to the pressure of the atmosphere. Finally, the metal base 10 on which the first insulation coating 11 has been formed is taken out of the sol 15 at a rate of 200 mm per minute. In this manner, the surface of the first insulation coating 11 is dip-coated with a layer of the sol 15 that is about several hundred micrometers in thickness. After that, the sol 15 is dried.

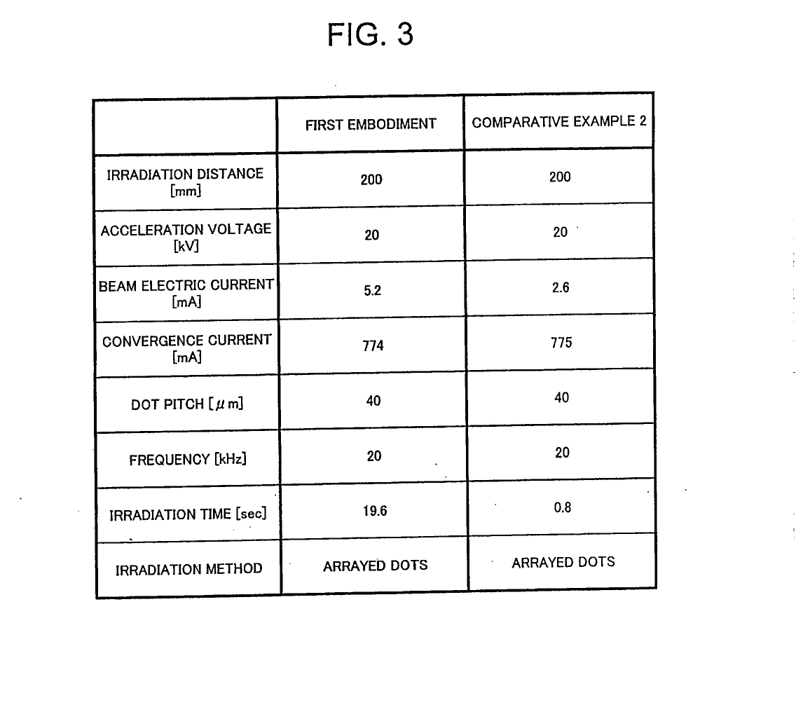

After the impregnation step (S2), under the irradiation conditions shown in FIG. 3, the first insulation coating 11 and the sol 15 are irradiated with an electron beam (Beam irradiation step (S3)). As the first insulation coating 11 and the sol 15 are irradiated with an electron beam, hydrated alumina, a component of the sol 15, becomes dehydrated, generating alumina; the first insulation coating 11 and the alumina are melted. At this time, the alumina at a depth of about 6 to 7 μm from the surface of the first insulation coating 11 is melted and solidified, and becomes densified as a result. The above-described steps produce the insulation-coated metal base of the present embodiment.

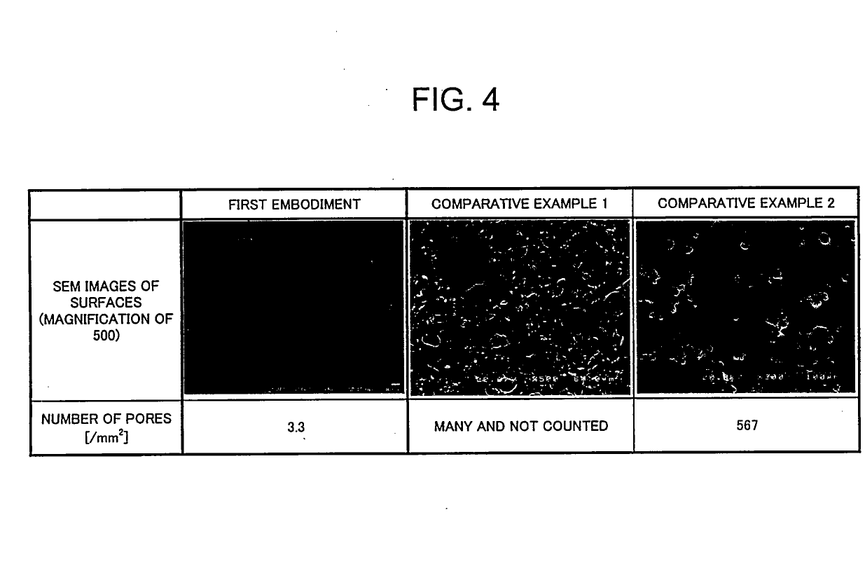

The advantageous effects obtained by the present embodiment will be described with the use of FIG. 4. FIG. 4 is a table showing SEM (Scanning Electron Microscope) images of surfaces of insulation-coated metal bases of the present embodiment and Comparative Examples 1 and 2, as well as the number of pores formed on the surfaces. As for the insulation-coated metal base of Comparative Example 1, an insulation coating is made as alumina is thermally sprayed onto a surface of the metal base. As for the insulation-coated metal base of Comparative Example 2, an insulation coating is made as alumina is thermally sprayed onto a surface of the metal base; a surface of the insulation coating is then irradiated with an electron beam under the irradiation conditions shown in FIG. 3.

As described above, as the insulation-coated metal bases are used for a long period of time, the edge portions of pores and microcracks formed on the surfaces become a source of particles. As shown in FIG. 4, according to the present embodiment, the pores on the surface of the insulation-coated metal base are smaller in number than Comparative Examples 1 and 2. Therefore, according to the present embodiment, even as the insulation-coated metal base is used for a long period of time, particles are less likely to emerge. Accordingly, if the insulation-coated metal base of the present embodiment is used for the semiconductor-manufacturing plasma CVD apparatus, particles are less likely to appear even as the surface of the insulation-coated metal base is exposed to plasma. Therefore, high-quality semiconductor devices can be produced.

Moreover, for the insulation-coated metal base of the present embodiment, as a sealer, the sol containing hydrated alumina as dispersoid is used. Therefore, compared with the case where a resin-based sealer is used, the insulation-coated metal base can be used at higher temperatures, and is high in heat resistance. Moreover, the dispersoid, or hydrated alumina, becomes dehydrated as the dispersoid is irradiated with an electron beam, turning into alumina, which is the same material as that of the first insulation coating. The above substances can be easily integrated, thereby suppressing the generation of particles. Furthermore, because the average particle diameter of the dispersoid, or hydrated alumina, is larger than or equal to 1 nm and smaller than or equal to 100 nm, even the small pores and microcracks are sealed, thereby suppressing the generation of particles.

The dispersion medium, or water, vaporizes during the drying and beam irradiation processes. Accordingly, even if the insulation-coated metal base is used at high temperatures, impurities do not emerge.

### Second Embodiment

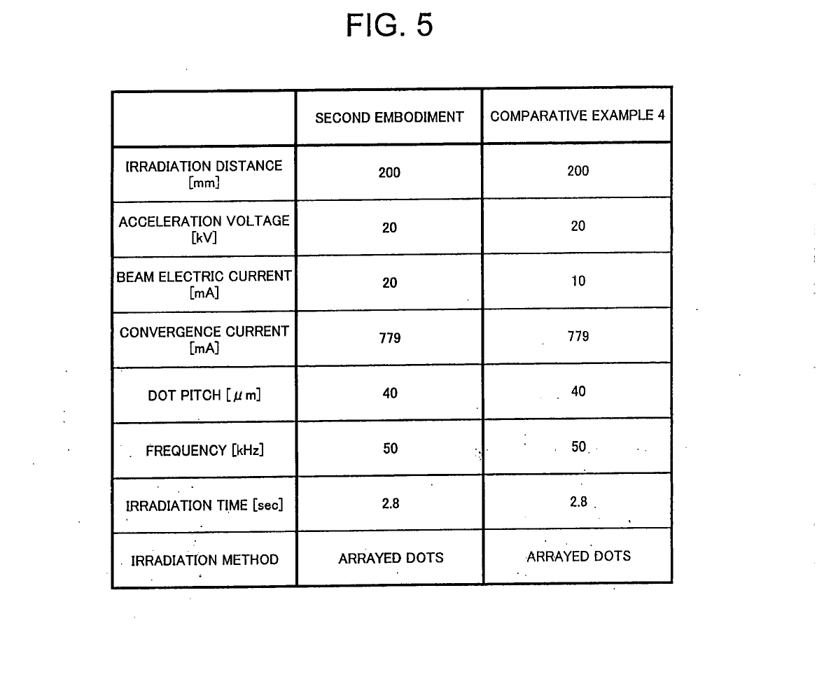

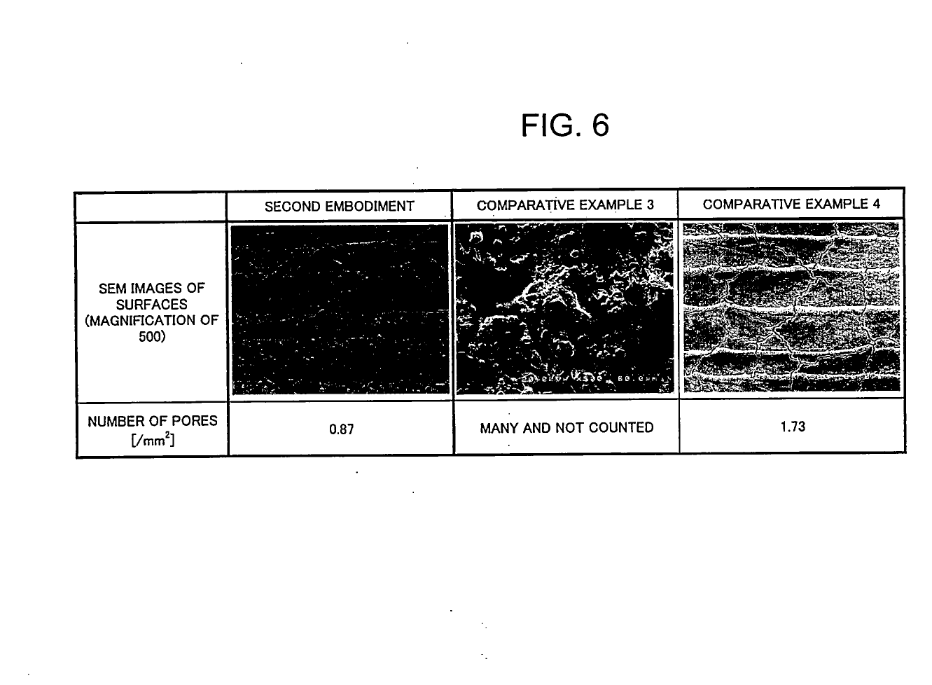

A metal-base insulation coating method and an insulation-coated metal base of a second embodiment of the present invention will be described with the use of FIGS. 5 and 6. FIG. 6 is a table showing SEM images of surfaces of insulation-coated metal bases of the second embodiment and Comparative Examples 3 and 4, as well as the number of pores formed on the surfaces.

According to the first embodiment, alumina is employed as a material of the first insulation coating, and hydrated alumina as the dispersoid of the sol. However, according to the present embodiment, yttria is employed as a material of the first insulation coating, and hydrated yttria (Y₂O₃.nH₂O) as the dispersoid of the sol. The insulation coating method of the metal base is the same as that in the first embodiment.

The advantageous effects obtained by the present embodiment will be described with the use of FIG. 6. FIG. 6 is a table showing SEM (Scanning Electron Microscope) images of surfaces of insulation-coated metal bases of the present embodiment and Comparative Examples 3 and 4, as well as the number of pores formed on the surfaces. As for the insulation-coated metal base of Comparative Example 3, an insulation coating is made as yttria is thermally sprayed onto a surface of the metal base. As for the insulation-coated metal base of Comparative Example 4, an insulation coating is made as yttria is thermally sprayed onto a surface of the metal base; a surface of the insulation coating is then irradiated with an electron beam.

It is clear from FIG. 6 that, according to the present embodiment, the pores formed on the surface of the insulation-coated metal base are smaller in number than Comparative Examples 3 and 4. Therefore, compared with Comparative Examples 3 and 4, even when the insulation-coated metal base of the present embodiment is used for a long period of time, particles are less likely to occur.

### Other Embodiments

The above embodiments are given for illustrative purposes only, and the present invention is not limited to the embodiments. For example, according to the above embodiments, as the dispersoid of the sol 15, hydrated metal oxides (hydrated alumina and hydrated yttria) are used. However, metal oxides (alumina and yttrium) and metal hydroxides (aluminum hydroxide (Al(OH)₃) and yttrium hydroxide (Y(OH)₃)) may be used. Even when the above substances are used, a second insulation coating made of metal oxide can be formed by the irradiation of an electron beam.

According to the above embodiments, the first and the second insulation coatings are made of the same material. However, for example, the first insulation coating may be made of alumina, and the second insulation coating of yttria.

According to the above embodiments, the metal base on which the first insulation coating has been formed is dipped into the sol. However, a spray or the like may be used to apply the sol to the surface of the first insulation coating.

According to the above embodiments, an electron beam is irradiated. However, for example, a high-energy beam, such as a laser beam, may be irradiated so that the material of the first insulation coating and the dispersoid of the sol can be melted.

What is claimed is:

1. A metal-base insulation coating method comprising:
a thermal spraying step of thermally spraying a first metal oxide to a surface of a metal base to form a first insulation coating;
an impregnation step of impregnating pores formed on a surface of the first insulation coating with sol containing a metal oxide, hydrated metal oxide, or metal hydroxide as dispersoid; and
a beam irradiation step of irradiating the first insulation coating and the sol with a high-energy beam after the impregnation step to form a second insulation coating made of a second metal oxide.

2. The metal-base insulation coating method according to claim 1, wherein
at the impregnation step, the metal base on which the first insulation coating is formed is dipped into the sol under vacuum, thereby impregnating pores formed on the surface of the first insulation coating with the sol.

3. The metal-base insulation coating method according to claim 1, wherein
average particle diameter of the dispersoid is larger than or equal to 1 nm and smaller than or equal to 100 nm.

4. The metal-base insulation coating method according to claim 1, wherein
dispersion medium of the sol is mainly made of water.

5. The metal-base insulation coating method according to claim 1, wherein
the first and the second metal oxides are same material.

6. The metal-base insulation coating method according to claim 5, wherein
the first and the second metal oxides are made mainly of alumina.

7. The metal-base insulation coating method according to claim 5, wherein
the first and the second metal oxides are made mainly of yttria.

8. The metal-base insulation coating method according to claim 1, wherein
the high-energy beam is an electron beam.

9. The metal-base insulation coating method according to claim 1, wherein
the high-energy beam is a laser beam.

10. An insulation-coated metal base, comprising:
a metal base;
a first insulation coating that is formed as a first metal oxide is thermally sprayed onto a surface of the metal base; and
a second insulation coating that is formed by irradiating the first insulation coating with high-energy beam, after pores formed on a surface of the first insulating coating is impregnated with sol that contains a metal oxide, hydrated metal oxide, or metal hydroxide as dispersoid.

11. A semiconductor manufacturing apparatus, comprising
an insulation-coated metal base that includes:
a metal base;
a first insulation coating that is formed as a first metal oxide is thermally sprayed onto a surface of the metal base; and
a second insulation coating that is formed by irradiating the first insulation coating with high-energy beam, after pores formed on a surface of the first insulating coating is impregnated with sol that contains a metal oxide, hydrated metal oxide, or metal hydroxide as dispersoid.

12. The metal-base insulation coating method according to claim 2, wherein
average particle diameter of the dispersoid is larger than or equal to 1 nm and smaller than or equal to 100 nm.

13. The metal-base insulation coating method according to claim 2, wherein
dispersion medium of the sol is mainly made of water.

14. The metal-base insulation coating method according to claim 2, wherein
the first and the second metal oxides are same material.

15. The metal-base insulation coating method according to claim 14, wherein
the first and the second metal oxides are made mainly of alumina.

16. The metal-base insulation coating method according to claim 14, wherein
the first and the second metal oxides are made mainly of yttria.

17. The metal-base insulation coating method according to claim 2, wherein
the high-energy beam is an electron beam.

18. The metal-base insulation coating method according to claim 2, wherein
the high-energy beam is a laser beam.
